(19) United States
(12) Patent Application Publication
(10) Pub. No.: US 2023/0007166 A1
(43) Pub. Date: Jan. 5, 2023

(54) Remote Control Camera Review Keychain

(71) Applicant: Corey L Harris, SR., Erie, PA (US)

(72) Inventor: Corey L Harris, SR., Erie, PA (US)

(21) Appl. No.: 17/366,048

(22) Filed: Jul. 2, 2021

(51) Int. Cl. H04N 5/232

(52) U.S. Cl. CPC H04N 5/23218

(57) ABSTRACT

A GPS accessible vehicle intrusion monitoring system that eliminates unnecessary image capture and transmission by providing security device that will monitor and record inside and outside of the vehicle. The connection between vehicle and owner is established with USB port which is portable and allows 24 hours monitoring to the user.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates to a UPS accessible system that monitors a vehicle and the like by using a camera to improve its security.

### Description of the Related Art

A conventional vehicle intrusion monitoring system for example, JP-A-11-328545) has a camera installed on the vehicle and the like to capture an image of an intruder when the vehicle is trespassed. A user of the system puts the system turned on to be in a watch state when the user leaves the vehicle. If any of the various types of onboard sensors detects an abnormality of the vehicle (opening of a door, break-in from a window etc.), the vehicle intrusion monitoring system captures an image by using a camera based on the assumption that the vehicle is trespassed. The captured image data is then transmitted to a base station.

Further, the other type of vehicle intrusion monitoring system (for example, JP-A-2002-157655) determines a trespassing based only on that a door lock is switched off for the first time, and a room lamp is turned on within three seconds of the switch-off of the door lock, while a watch state of the vehicle intrusion monitoring system is turned on.

However, intrusion detection in the conventional art is not necessarily satisfactory. That is, the camera of the vehicle intrusion monitoring system captures and transmits the captured image data even when an intruder is not in the vehicle, or when the intruder stops robbery on noticing the camera, or when a passer-by casually breaks a window without an intention of intrusion. In those cases, the captured and transmitted image does not provide a clue to the intruder.

As a consequence, the battery of the conventional system runs down by capturing and transmitting unnecessary image data, and incurs unnecessary expenditure on the user of the system when the transmission means uses a subscription service such as a telephone line. Moreover, the unnecessary captured image data is annoying for the user.

Further, the image area captured by the camera is not necessarily limited inside the vehicle, but also includes the outside of the vehicle through side windows, rear windows and the like. Thus, capturing an image of potential intruder around the vehicle by the camera upon detection of an abnormality of the vehicle can improve the usefulness of the vehicle intrusion monitoring system.

The instant invention attempts to overcome deficiencies of the prior art by providing a security device that will monitor and record inside and outside of the vehicle USB port portability. The user will be able to carry the keychain with him/her so that user can have 24-hour access and monitor vehicle outside activity throughout the day handheld keychain.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description, A full appreciation of the various aspects of the invention can be gained by taking the entire specification, claims, drawings, and abstract as a whole.

The primary object of the invention is related to an advancement in offering GPS accessible Remote control camera review keychain for vehicle's surveillance.

It is further the objective of the invention to create a safe, durable, and easy to use USB port security device that will monitor inside and outside of vehicle.

It is moreover the objective of the invention to capture, by using a camera, an image of a malicious passer-by who attempts to cause damage to the vehicle from outside (without intrusion).

It is another object of the present invention to provide a new and improved 24-hour surveillance on vehicle operation area of the vehicle.

It is a further object of the present invention to provide a new and improved USB surveillance apparatus which is of a durable and reliable construction.

An even further object of the present invention is to provide a new and improved apparatus which is susceptible of a low cost of manufacture with regard to both materials and labor, and which accordingly is then susceptible of low prices of sale to the consuming public, thereby making such apparatus economically available to the buying public.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a showing the front view as per preferred embodiments of the invention.

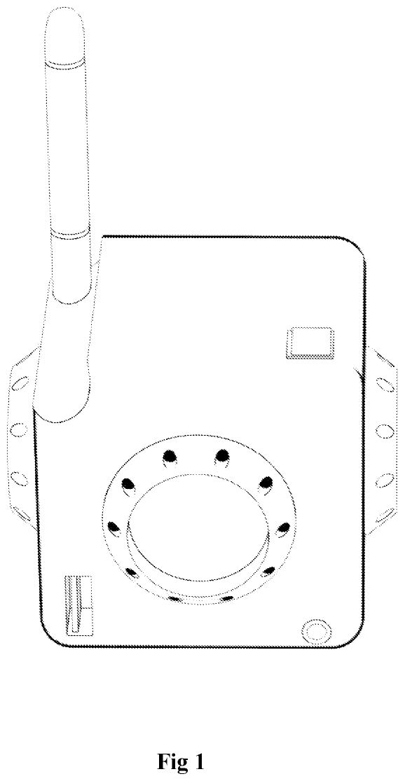

FIG. 2 shows the keychain as per preferred embodiments of the invention.

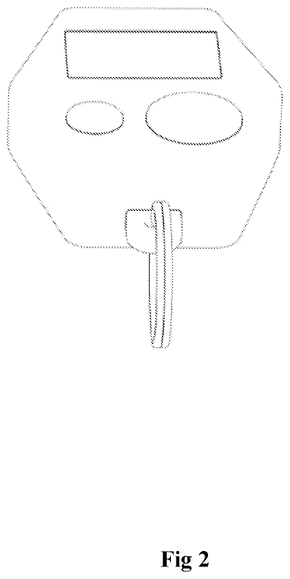

FIG. 3 shows top view as per preferred embodiments of the invention.

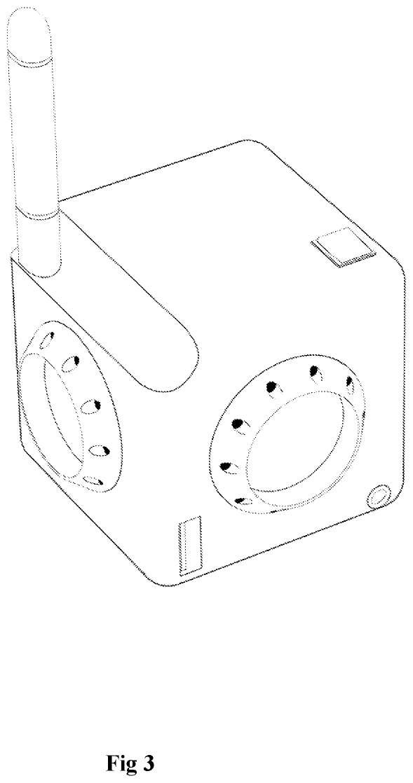

FIG. 4 shows the front view of the key chain as per preferred embodiments of the invention.

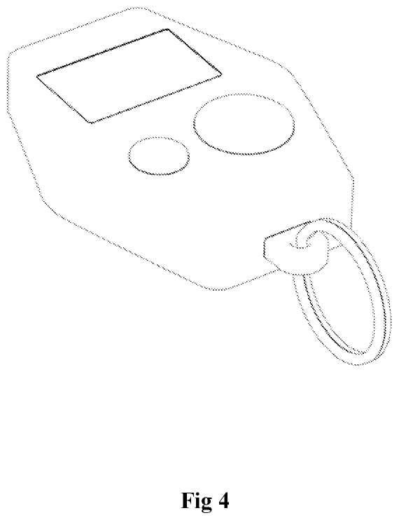

FIG. 5 shows the side close view per preferred embodiments of the invention.

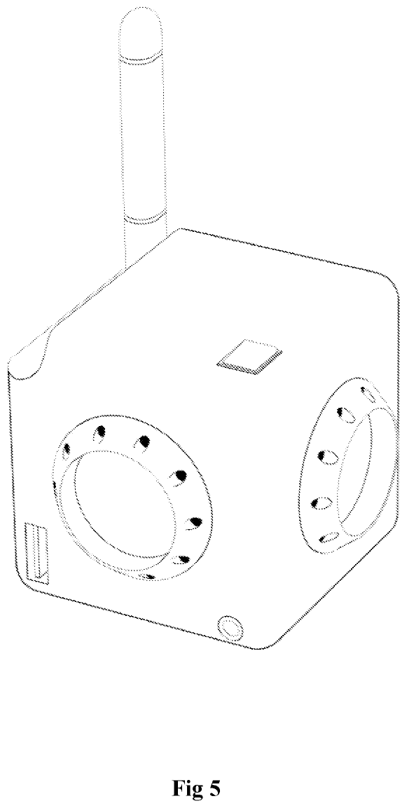

FIG. 6 shows the full key chain view as per preferred embodiments of the invention.

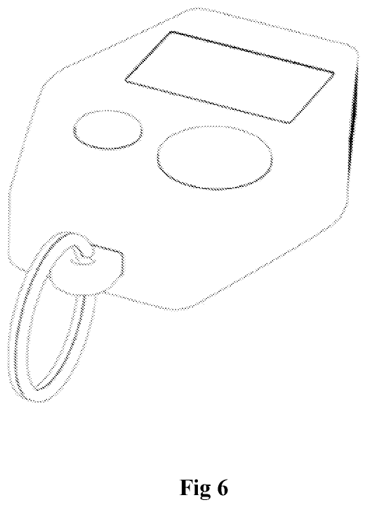

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

More specifically, the instant invention claims a GPS accessible surveillance device which provides round the clock security with limited hassle from user's end.

The security device as per its preferred embodiments monitor's and record the outside area and inside of vehicle. The proposed assembly can be carried with a key chain, thus allowing enhanced portability and ease of use.

To achieve the above object, a vehicle intrusion monitoring system includes a system controlling part (a control ECU and a communication ECU) to direct commands and to receive data, a camera to capture an image of an intruder, an intrusion detector and various kinds of sensors to pick up intrusion and damage to the vehicle, and a radio communication device to send the captured images and related information.

The vehicle intrusion monitoring system captures the first image upon detecting the first abnormality after the system is turned on, and then captures the second image only when it detects an intrusion into the vehicle, that is, intrusion into a driver's seat, a passenger's seat, or other compartments of the vehicle. According to this scheme of capturing image, the system can eliminate unnecessary image capturing and transmission, because intrusion into the vehicle is critical in terms of image capturing as evidence collection.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A GPS accessible vehicle intrusion monitoring system comprising:
at least one camera on a vehicle;
a USB port to establish connectivity between vehicle and owner;
an abnormality detection means that at least detects an intruder and multiple abnormalities on the vehicle and;
a control means that outputs a capture command to the camera based on a signal from the abnormality detection means when the vehicle is in a watch state.
